(19) United States
(12) Patent Application Publication
(10) Pub. No.: US 2010/0072845 A1
(43) Pub. Date: Mar. 25, 2010

(54) METHOD FOR DETERMINATION OF RESONANT FREQUENCIES OF A ROTOR USING MAGNETIC BEARINGS

(75) Inventor: Ulrich Jung, Limberg (DE)

Correspondence Address: FAY SHARPE LLP, 1228 Euclid Avenue, 5th Floor, The Halle Building, Cleveland, OH, 44115, US

(73) Assignee: OERLIKON LEYBOLD VACUUM GMBH, KOELN (DE)

(21) Appl. No.: 12/522,054

(22) PCT Filed: Jan. 3, 2008
(86) PCT No.: PCT/EP2008/050043

§ 371 Date: Jul. 2, 2009

(30) Foreign Application Priority Data
Jan. 5, 2007 (DE) 10 2007 001 201.4

(51) Int. Cl. H02K 7/09

(52) U.S. Cl. 310/90.5

(57) ABSTRACT

The resonant frequencies of a rotor supported on magnetic bearings, in particular a rotor of a turbomolecular vacuum pump, are determined. While the rotor is stationary or the rotor is rotating at a relatively low rotation frequency, mechanical oscillations of the rotor are generated by electromagnets in the magnetic bearing. The rotor oscillations are detected by rotor-position sensors in the magnetic bearing. The resonant frequencies of the rotor are determined from the detected rotor-position oscillations.

The invention refers to a method for the determination of resonant frequencies of a rotor supported by an active magnetic bearing.

Because of their frictionless nature, machines with a magnetically levitated rotor are generally fast rotating machines, such as turbomolecular vacuum pumps. In all applications, but especially with high-speed rotors, the rotational frequency of the rotor must be controlled such that the critical natural frequency of the rotor, i.e. the so-called resonant frequency, possibly does not at all coincide with the rotational frequency or does so only as shortly as possible so as to avoid or minimize resonance and to thereby avoid mechanical over-straining of the rotor.

In addition, the gap between the pump rotor and the pump stator in turbo-molecular vacuum pumps is extremely small to keep the back-leakage conductance at a minimum. Excessive deflections of the pump rotor that might result in a collision with the pump stator must be avoided at any rate. For this reason, it should be avoided to operate a magnetically levitated turbomolecular pump near the resonant frequency of the rotor.

With rotors or turbomolecular vacuum pumps of the prior art, the resonant frequencies for each model are determined by experiments and the control or regulation of the rotational speed of the pumps of a respective model are rigidly set such that the rotor resonant frequencies are avoided or are swept as fast as possible during the power up or power down. Due to the specimen-related variation within a model and possible changes over the entire operation cycle, comparatively large safety margins should be provided around an experimentally determined resonant frequency of a model.

In view of this, it is an object of the invention to provide a method with which the resonant frequencies of a magnetically levitated rotor can always be determined precisely.

This object is achieved, according to the invention, with a method having the features of claim 1.

The method of the invention is exclusively directed to a magnetically levitated rotor as it is frequently used in particular in turbomolecular vacuum pumps.

During a rotor standstill or when the rotor rotates at a frequency not too close to the rated rotational frequency of the rotor, the electromagnets of the magnetic bearing of the rotor generate mechanical oscillations of the rotor. At the same time, rotor-position sensors of the magnetic bearing detect or sense the generated rotor oscillations. From the oscillations detected and the information about the frequency of the generated oscillations, the resonant frequencies of the rotor can be determined.

The resonant frequencies of the rotor are thus determined at rotational frequencies of the rotor that do not induce a mechanical resonance of the rotor. The determination of the resonance frequencies described can be performed while the rotor is stationary. However, the determination of the resonant frequencies is more precise when the rotor is rotating slowly, since the resonance frequency of the rotor changes with its dynamic load during rotation.

Preferably, the frequencies of the generated oscillations range at least partly above the rotational frequency of the rotor. In other words: by generating mechanical rotor oscillations by the magnetic bearing, the rotor need not be excited rotationally in order to be able to determine its resonant frequencies.

However, the higher the rotational frequency of the rotor is during the determination of the resonant frequencies of the rotor, the more accurate the resonant frequency can be determined. On the other hand, the rotational frequency of the rotor should be as low as possible during the determination of the resonant frequency, so as to reduce the risk of collision and to limit the damage in the event of a collision. Moreover, the determination of the resonant frequency at low rotational frequencies of the rotor or at standstill allows for a quick determination of the resonant frequencies since a protracted increase of the rotational frequency of the rotor can be omitted or takes but little time. The actual determination of the resonant frequencies of the rotor may possibly be done within a few seconds.

According to a preferred embodiment, during the generation of the oscillations, the rotational frequency of the rotor is less than 70% of the rated rotational frequency of the rotor and it is particularly preferred to be less than 30%. Tests have shown that rotational frequencies of the rotor of 10% of the rated rotational frequency of the rotor already allow for a determination of the resonant frequencies of the rotor with a sufficiently high accuracy.

The exact determination of the resonant frequencies of the rotor makes it possible to select a rated rotational frequency of the rotor even between two resonant frequencies of the rotor. The exact item-related determination of the resonant frequency allows to determine frequency bands for the operation of the rotor, which without a precise knowledge of the resonant frequency could possibly not be used because of the safety margins required in this case.

Compared to using resonant frequencies that are first determined with reference to a model and are then fixedly stored in all items of a model, the present method is advantageous in that it allows to determine resonant frequencies individually for each single rotor. Since the resonant frequencies determined for each single rotor are individually known, the rotor can generally be driven at rotational frequencies closer to the individual resonant frequencies of the rotor, since no corresponding safety margins have to be provided for variations as they would have to be provided for fixedly programmed resonant frequencies. Especially with turbomolecular vacuum pumps, it has been found that significant item-related variations of the critical resonant frequencies can be determined from one item of a model to the next so that knowing the actual rotor-related resonant frequencies offers great advantages.

Determining the resonant frequencies with the method described can be performed upon the first start-up of the machine having the rotor, but may alternatively or additionally be done at regular intervals or after longer periods of standstill.

Preferably, the electromagnets of the magnet bearing generate mechanical oscillations of different oscillation frequencies. For instance, it is possible to generate oscillations of the entire rotational frequency spectrum in which the respective machine or the respective rotor is to be used. The frequency spectrum intended to be generated in the rotor by the electromagnets of the magnetic bearing may, however, be restricted to the critical ranges known and typical for the respective model of the machine or the rotor.

In a preferred embodiment, the method refers to the determination of resonant frequencies of a magnetically levitated rotor of a turbomolecular vacuum pump. In such a machine, the gaps between the pump rotor and the pump stator are extremely small so that operating the rotor at or near its resonant frequency entails a significant risk of collision. When using fixedly programmed model-specific resonant frequencies of a rotor, substantial safety margins have to be taken into account because of item variations. By determining the resonant frequencies for a respective rotor or a respective vacuum pump, these safety margins can be selected a lot narrower so that the turbomolecular vacuum pump can be operated at rotational frequencies that are much closer to the resonant frequency than would be the case with fixedly programmed model-specific resonant frequencies.

An embodiment of the invention will be detailed hereunder.

The invention will be explained in detail with reference to a turbomolecular vacuum pump. Among others, the rotor of a turbomolecular vacuum pump consists of a shaft on which a motor rotor and a pump rotor are rigidly mounted. Further, the shaft may be provided with rotor-side components of the magnet bearing, for instance, permanent magnetic sleeves, rings, etc.

On the stator side, a pump stator, a motor stator and stator-side components of the magnet bearing are provided among others. The stator-side components of the magnetic bearing include, among others, a plurality of electromagnets controlled by a magnet bearing control. Moreover, rotor-position sensors are provided on the stator side that are adapted to determine the exact position of the rotor at a high measuring frequency and with high accuracy.

When the rotor is at a standstill, a stationary test run is performed prior to the first start-up as well as at regular intervals before powering the rotor up to its operating rotational frequency. Here, the electromagnets of the magnetic bearing maintain the rotor in a floating operating position and is subjected to mechanical oscillations. Thus, the magnetic bearing generates rotor oscillations over a frequency spectrum in which a resonant frequency or a plurality of resonant frequencies specific to the structure or the model of the vacuum pump are expected.

The rotor-position sensors determine whether the rotor oscillations of the respective oscillation frequency generated by the electromagnets of the magnetic bearing build up or not.

In this manner, the resonant frequency of the rotor, which may also change over the operation cycle, can be determined at any time with high accuracy.

For the operation of the rotor, relatively narrow frequency bands can be provided as a safety margin around the detected resonant frequency of the rotor. The rotor or the turbomolecular vacuum pump can thus be operated at rotational frequencies which are, if desired, relative close to a resonant frequency determined in this manner. To be able to operate the turbomolecular vacuum pump in the supercritical rotational frequency range, i.e. in a rotational frequency range above a resonant frequency, the region around the resonant frequency must be swept as quickly as possible. Also for the powering up of a vacuum pump to a supercritical rotational speed frequency, an exact information about the resonant frequency of the rotor is of great importance.

Possibly, the maximum rotational frequency can be selected as close as possible below the resonant frequency of the rotor. The exact determination of the resonant frequency allows to select an operating rotational frequency that may be higher than and thus closer to a resonant frequency than would be possible if the item variation of the resonant frequency were not known. Thus, the maximum rotational frequency of a turbomolecular vacuum pump can be increased by up to 10%-15%.

1. A method for the determination of resonant frequencies of a rotor using magnetic bearings, comprising the following steps:
generating mechanical oscillations of the rotor by electromagnets of the magnetic bearing,
detecting the rotor oscillations by means of rotor-position sensors of the magnetic bearing, and
determining the resonant frequencies of the rotor from the detected oscillations.

2. The method of claim 1, wherein the frequencies of the oscillations generated range at least partly above a rotational frequency of the rotor.

3. The method of claim 1, wherein the oscillations are generated with a rotational frequency of the rotor less than 70% of a rated rotational frequency of the rotor.

4. The method of claim 1, further including generating the mechanical oscillations at a plurality of oscillation frequencies.

5. The method of claim 1, further including generating the mechanical oscillations at a plurality of oscillation frequencies of a frequency spectrum.

6. The method of claim 1, wherein the rotor using magnetic bearings is a rotor of a turbomolecular vacuum pump.

7. The method of claim 1, wherein the oscillations are generated with a rotational frequency of the rotor less than 30% of a rated rotational frequency of the rotor.

8. A method of determining resonant frequencies of a rotor, the method comprising:
(a) rotating a rotor which is supported by electromagnetic bearings at a rotational speed below a rated rotational speed;
(b) controlling the electromagnetic bearings to cause the rotor to oscillate at each of a plurality of oscillation frequencies over a range of rotational frequencies;
(c) detecting rotor oscillations with rotor position sensors of the electromagnetic bearings;
(d) from the detected rotor oscillations, determining resonance frequencies of the rotor.

9. The method of claim 8, further including:
controlling the rotor to operate at rotational frequencies other than one of the determined resonance frequencies of the rotor.

10. The method of claim 9, further including:
when powering up to a selected operating frequency, controlling to rotor to sweep through any determined resonance frequencies lower than the selected operating frequency as quickly as possible.

11. The method of claim 8, wherein the rotor is a rotor of a turbomolecular vacuum pump and the method further includes:
repeating steps (a)-(d) for each of a plurality of turbomolecular vacuum pumps such that resonance frequencies are determined individually for each of the turbomolecular vacuum pumps.
